(19) United States
(12) Patent Application Publication
(10) Pub. No.: US 2014/0303301 A1
(43) Pub. Date: Oct. 9, 2014

(54) COMPOSITION WITH IMPROVED LONG TERM SCRATCH RESISTANCE AND REDUCED SURFACE TACK

(71) Applicants: Klaus Lederer, Linz (AT); Erwin Kastner, Linz (AT); Georg Grestenberger, St. Peter in der Au (AT)

(72) Inventors: Klaus Lederer, Linz (AT); Erwin Kastner, Linz (AT); Georg Grestenberger, St. Peter in der Au (AT)

(73) Assignee: Eni S.P.A., Vienna (AT)

(21) Appl. No.: 14/237,725

(22) PCT Filed: Aug. 8, 2012
(86) PCT No.: PCT/EP2012/065517

§ 371 Date: Mar. 12, 2014

(30) Foreign Application Priority Data
Aug. 11, 2011 (EP) 11177311.5

(51) Int. Cl. C08K 5/20; C08L 23/14

(52) U.S. Cl. CPC C08K 5/20; C08L 23/14
USPC 524/229

(57) ABSTRACT

Automotive interior article comprising a composition comprising a heterophasic propylene copolymer (HECO), and a fatty acid amide derivative of formula (I) wherein R₁ is a C₅ to C₂₅ alkyl residue or C₅ to C₂₅ alkenyl residue, R₂ is a long-chain organic residue containing at least 6 carbon atoms.

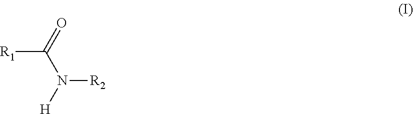

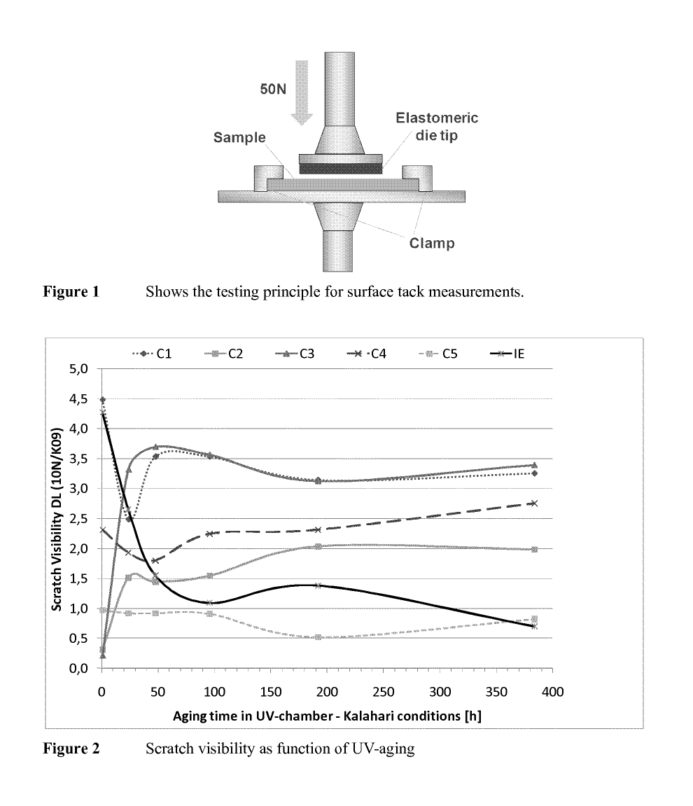

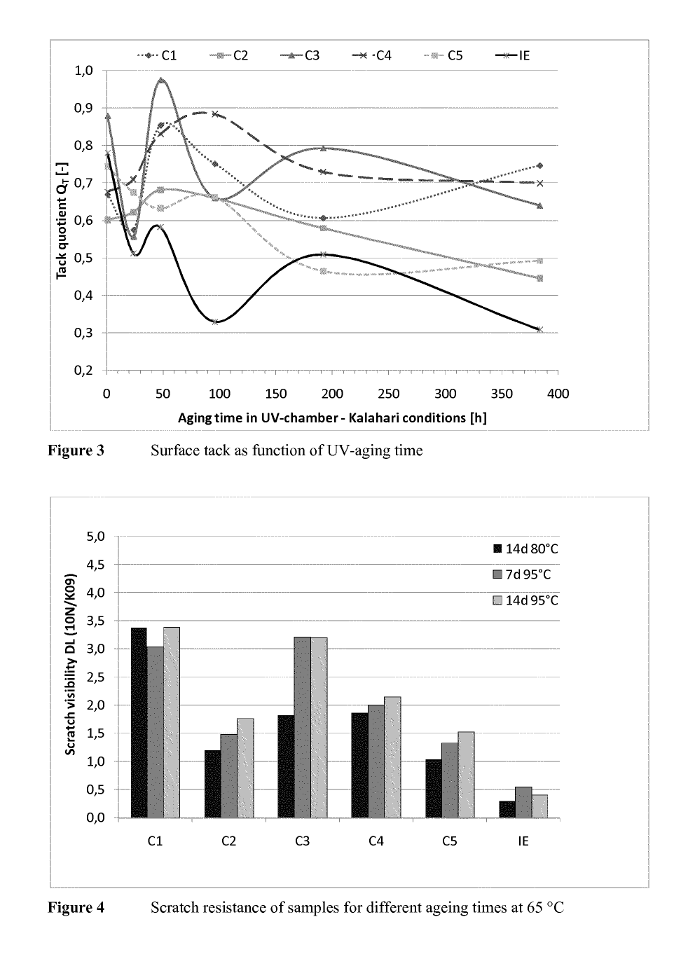

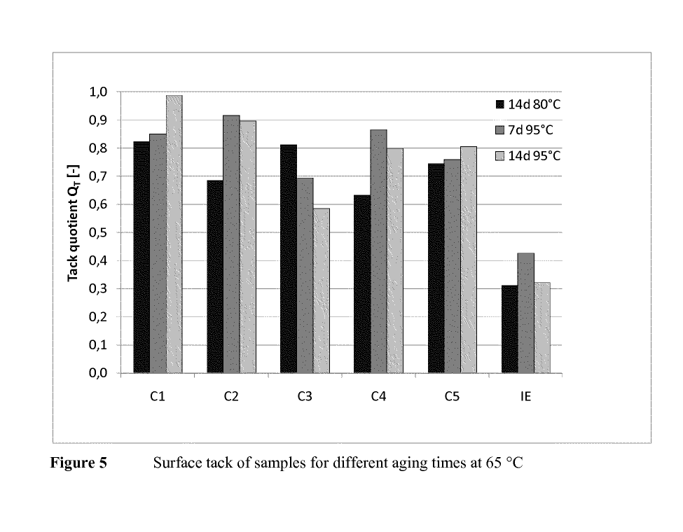

The present invention is directed to a new automotive interior article comprising a composition comprising a heterophasic propylene copolymer (HECO) and a specific fatty acid amide derivative. Furthermore the present invention relates to use of a composition as well as of a slip agent to improve surface tack and/or scratch resistance.

Automotive interior parts like dashboards, door claddings, trims etc. are commonly made from polymers. Especially propylene based resins and in particular TPO/talc compounds are widely used for these applications.

For such parts it is often tried to mimic a leather- or fabric-like surface and touch in order to give occupants a high-quality impression of the car. As a result materials should provide a low surface gloss level and good haptics respectively low values for surface tack. Additionally to maintain the high-quality perception of the parts till the end of the car's lifetime the polymer should provide a high resistance to scratches e.g. from keys, fingernails, rings etc.

In comparison to metals polymers have rather low stiffness and surface hardness and hence are much more prone to scratches apart from material design and filler addition usually additives are used to overcome this drawback.

WO 2006/131455A1 discloses a scratch resistant polyolefin compound containing a specific additive combination, said compound comprises the following components

a) a polyolefin substrate and an amount effective to improve the scratch resistance and light stability of said polyolefin substrate of an additive combination of
b) a carboxylic acid reagent functionalized olefin polymer or copolymer, c) a primary or secondary fatty acid amide and d) a combination of i) a low molecular weight sterically hindered amine light stabilizer and ii) a high molecular weight sterically hindered amine light stabilizer.

In EP 2083046 A1 a thermoplastic elastomer composition is disclosed comprising a thermoplastic polymer, an ethylene-alpha olefin plastomer and a peroxide. Said composition features an improved scratch resistance and no to low gloss change of the finished product during heat ageing (60° gloss measured on grain VWK09 96 h at 120° C.).

It is known to people skilled in the art that scratch resistance of TPO/talc compounds can be improved by the addition of slip agents e.g. compare WO 2007/139622 A3, WO 02/22731 A2, WO 2005/111145 A1, WO 2006/063698 A1. Slip agents like fatty acid amides (Eruc-amide, Oleamide, Stearamide, Behenamide etc.) reduce the coefficient of friction of poly-meric surfaces by migrating from the bulk to the surface. In some of the above mentioned applications also polyethylene is added (preferably high density polyethylene (HDPE)). Polyethylene affects the morphology of the dispersed rubber phase stabilizing the surface and immediate subsurface layer of injection mouldings.

In combination both mechanisms lead to very cost efficient scratch resistant material formu-lations. However apart from scratch resistance and gloss also haptics is becoming more and more important for interior applications. One factor in this respect is the surface tack of a part. Unfortunately it was claimed several times that fatty acid amides lead to a tacky feel of the surface (e.g. Huber, G.; Solera, P.: New Additive to Improve Scratch Resistance and Reduce Surface-Tack for Automotive Applications. First Automotive Congress—Plastics in Motion 2006; Botkin, J.: Technical Approaches to Improving the Scratch Resistance of TPO's. Part 1: Surface Lubrication. SPE Automotive TPO Global Conference 2007). Therefore alternative routes to improve the scratch performance of compounds at reasonable cost are targeted.

Polydimethylsiloxanes are known to improve scratch resistance combined with good haptics (compare e.g. EP 2083046 A1, Botkin, J.: Technical Approaches to Improving the Scratch Resistance of TPO's. Part 1: Surface Lubrication. SPE Automotive TPO Global Conference 2007). However main drawback of this type of scratch resistance additives is their high price combined with high required loading (typically 2 to 3 wt.-%).

Accordingly the object of the present invention is to provide an additive which enables a skilled person to provide a polypropylene with improved long term scratch resistance as well as reduced surface tack. A further object of the present invention is to provide an automotive interior article with improved long term scratch resistance and reduced surface tack.

The finding of the present invention is that one slip agent must be used being a fatty acid amide derivative.

Thus the present invention is directed to an automotive interior article comprising a composition comprising

(a) a heterophasic propylene copolymer (HECO), and
(b) a fatty acid amide derivative of formula (I)

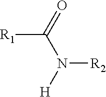

wherein R₁ is a C₅ to C₂₅ alkyl residue or C₅ to C₂₅ alkenyl residue,
R₂ is a long-chain organic residue containing at least 6 carbon atoms.

The present invention discloses a simple and cost effective solution to provide an automotive interior article with long term scratch resistance and at the same time reduced surface tack.

The present invention provides in particular automotive articles, like injection molded articles, comprising at least to 60 wt.-%, preferably at least 80 wt.-%, more preferably at least 95 wt.-%, and most preferably consisting of the composition. Accordingly the present invention is especially directed to automotive interior articles, especially to body panels, dashboards, interior trims and the like, comprising at least to 60 wt.-%, preferably at least 80 wt.-%, more preferably at least 95 wt.-%, and most preferably consisting of the composition.

In following the compounds of the present invention are described in more detail.

### Heterophasic Propylene Copolymer (HECO)

One essential component is the presence of a heterophasic propylene copolymer. Heterophasic polymer systems are well known in the art and are systems in particular obtained in a process comprising at least two steps resulting in a multiphase structure comprising a polypropylene matrix and inclusions therein comprising amorphous elastomer. Such systems can be easily tailored for the automotive requirements by setting the comonomer content in the polypropylene matrix and in the elastomeric phase respectively.

More precisely, a heterophasic propylene copolymer (HECO) according to this invention comprises as matrix a random propylene copolymer or a propylene homopolymer and dispersed therein an elastomeric propylene copolymer. Thus the matrix contains (finely) dispersed inclusions being not part of the matrix and said inclusions contain the elastomeric propylene copolymer. The term inclusion indicates that the matrix and the inclusion form different phases within the heterophasic propylene copolymer (HECO), said inclusions are for instance visible by high resolution microscopy, like electron microscopy or scanning force microscopy.

Preferably the heterophasic propylene copolymer (HECO) may contain further additives but no other polymer in an amount exceeding 5 wt.-%, more preferably exceeding 3 wt.-%, like exceeding 1 wt.-%, based on the total amount of the heterophasic polymer. One additional polymer which may be present in such low amounts is a polyethylene which is a reaction product obtained by the preparation of the heterophasic propylene copolymer (HECO). Accordingly it is in particular appreciated that a heterophasic propylene copolymer (HECO) as defined in the present invention contains only a polypropylene matrix, an elastomeric propylene copolymer, and optionally a polyethylene in amounts as mentioned in this paragraph.

Preferably the propylene content in the heterophasic polymer is in the range of 70 to 92 wt.-%, more preferably in the range of 75 to 85 wt.-%, yet more preferably in the range of 78 to 82 wt.-%, based on the total amount of the heterophasic propylene copolymer (HECO), more preferably based on the amount of the polymer components of the heterophasic propylene copolymer (HECO), yet more preferably based on the amount of the polypropylene matrix and the elastomeric propylene copolymer together. The remaining part constitutes the comonomers as defined for the polypropylene matrix being a random propylene copolymer and the elastomeric propylene copolymer, respectively, preferably ethylene. Accordingly the comonomer content, preferably ethylene content, for the total heterophasic propylene copolymer (HECO) is in the range of 8.0 to 30.0 wt.-%, more preferably in the range of 15.0 to 25.0 wt.-%, still more preferably in the range of 18.0 to 22.0 wt.-%, based on the total amount of the heterophasic propylene copolymer (HECO), more preferably based on the amount of the polymer components of the heterophasic propylene copolymer (HECO), yet more preferably based on the amount of the polypropylene matrix and the elastomeric propylene copolymer together.

The polypropylene matrix of the heterophasic propylene copolymer (HECO) can be made of the propylene homo- and/or copolymer only but can also comprise additional polymers, in particular polymers which can be blended homogeneously with the propylene homo- or copolymer and together form a continuous phase which can act as a matrix. In a preferred embodiment, at least 80 wt.-% of the matrix, more preferably at least 90 wt.-%, even more preferably at least 95 wt.-% of the matrix are made of the propylene homo- and/or copolymer. Even further preferred, the matrix consists of the propylene homo- and/or copolymer.

The propylene homo- and/or copolymer forming the matrix can be a random propylene copolymer or a propylene homopolymer. In a preferred embodiment, the matrix is a propylene homopolymer.

For the purpose of the present invention, the expression “propylene homopolymer” refers to a polypropylene that consists substantially, i.e. of at least 97 wt.-%, preferably of at least 98 wt.-%, more preferably of at least 99 wt.-%, most preferably of at least 99.8 wt.-% of propylene units. In a preferred embodiment only propylene units in the propylene homopolymer are detectable.

In case the propylene homo- and/or copolymer forming the matrix is a random propylene copolymer it comprises monomers copolymerizable with propylene, for example comonomers such as ethylene and/or C₄ to C₁₂ α-olefins, in particular ethylene and/or C₄ to C₁₀ α-olefins, e.g. 1-butene and/or 1-hexene. Preferably the random propylene copolymer comprises, especially consists of, monomers copolymerizable with propylene from the group consisting of ethylene, 1-butene and 1-hexene. More specifically the random propylene copolymer comprises—apart from propylene—units derivable from ethylene and/or 1-butene. In a preferred embodiment the random propylene copolymer comprises units derivable from ethylene and propylene only. The comonomer content in the random propylene copolymer is preferably in the range of more than 0.5 to 10.0 wt.-%, still more preferably in the range of more than 0.5 to 7.0 wt.-%.

The propylene homo- and/or copolymer matrix can have a xylene cold soluble content (XCS) in a broad range, i.e. up to 6.0 wt.-%, based on the total amount of propylene homo- and/or copolymer matrix. Accordingly the propylene homo- and/or copolymer matrix may have a xylene cold soluble content (XCS) in the range from 0.3 to 6.0 wt.-%, e.g., from 0.5 to 5.5 wt.-%, based on the amount of the propylene homo- and/or copolymer matrix.

According to a preferred embodiment the matrix is a propylene homopolymer having a xylene cold soluble (XCS) content in the range from 0.5 to 4.5 wt.-%, more preferably in the range from 0.8 to 4.0 wt.-%, still more preferably from 0.8 to 3.5 wt.-%.

According to one embodiment of the present invention, the polypropylene matrix has a melt flow rate MFR₂ (230° C.) of 10 to 300 g/10 min, preferably in the range from 25 to 150 g/10 min, more preferably in the range from 30 to 120 g/10 min.

Accordingly it is preferred that the propylene homo- and/or copolymer forming the matrix has a weight average molecular weight (Mw) from 100000 to 400000 g/mol, preferably from 150000 to 350000, more preferably from 175000 to 300000 g/mol.

In addition to the polypropylene matrix phase, the heterophasic propylene copolymer (HECO) comprises an elastomeric propylene copolymer which is dispersed within said matrix.

According to one embodiment, the elastomeric propylene copolymer comprises monomers copolymerizable with propylene, for example, comonomers such as ethylene and/or C₄ to C₁₂ α-olefins, preferably ethylene and/or C₄ to C₁₀ α-olefins, e.g. 1-butene and/or 1-hexene. Preferably the elastomeric propylene copolymer comprises, especially consists of, monomers copolymerizable with propylene from the group consisting of ethylene, 1-butene and 1-hexene. More specifically the elastomeric propylene copolymer comprises—apart from propylene—units derivable from ethylene and/or 1-butene. Thus, in an especially preferred embodiment the elastomeric propylene copolymer phase comprises units derivable from ethylene and propylene only.

In case the polypropylene matrix is a random propylene copolymer it is preferred that the comonomer(s) of the random propylene copolymer and the elastomeric propylene copolymer are the same.

The properties of the elastomeric propylene copolymer mainly influence the xylene cold soluble (XCS) content of the heterophasic propylene copolymer (HECO). Thus, according to the present invention the xylene cold soluble (XCS) fraction of heterophasic propylene copolymer (HECO) is regarded as the elastomeric propylene copolymer of the heterophasic propylene copolymer (HECO).

According to one embodiment of the present invention, the amount of the elastomeric propylene copolymer, i.e. of the xylene cold soluble (XCS) fraction, of the heterophasic propylene copolymer (HECO) is in the range from 15 to 50 wt.-%, preferably in the range from 20 to 40 wt.-%, and more preferably in the range from 25 to 38 wt.-%, based on the total amount of the heterophasic propylene copolymer (HECO).

A further preferred requirement of the present invention is that the intrinsic viscosity (IV) of the xylene cold soluble (XCS) fraction of the heterophasic propylene copolymer (HECO) is rather high. Rather high values of intrinsic viscosity improve the impact strength. Accordingly it is appreciated that the intrinsic viscosity of the xylene cold soluble (XCS) fraction of heterophasic propylene copolymer (HECO) is above 1.5 dl/g, more preferably at least 1.8 dl/g, yet more preferably at least 2.0 dl/g, like at least 2.3 dl/g. On the other hand the intrinsic viscosity should be not too high otherwise the flowability is decreased. Thus the intrinsic viscosity of the xylene cold soluble (XCS) fraction of the heterophasic propylene copolymer (HECO) is preferably in the range of 1.8 to 4.5 dl/g, more preferably in the range 2.0 to 4.1 dl/g, still more preferably 2.3 to 4.0 dl/g.

According to one embodiment, the heterophasic propylene copolymer (HECO) of the present invention has a rather high melt flow rate. Accordingly it is preferred that the heterophasic polymer has a melt flow rate MFR₂ (230° C.) of at least 8 g/10 min, more preferably in the range from 8 to 300 g/10 min, and most preferably in the range from 10 to 100 g/10 min, still more preferably in the range from 10 to 80 g/10 min

Processes for preparing heterophasic polymer systems are well known in the art, and are multi-step processes containing at least two process steps. A preferred multistage process is a “loop-gas phase”-process, such as developed by Borealis A/S, Denmark (known as BORSTAR® technology) described e.g. in patent literature, such as in EP 0 887 379, WO 92/12182 WO 2004/000899, WO 2004/111095, WO 99/24478, WO 99/24479 or in WO 00/68315. A further suitable slurry-gas phase process is the Spheripol® process of Basell.

According to one embodiment of the present invention, the heterophasic propylene copolymer (HECO) is obtained by producing the polypropylene matrix phase in at least one reactor, transferring said matrix phase in at least one subsequent reactor, where in presence of the matrix the elastomeric propylene copolymer is produced.

A suitable catalyst for the polymerization of the heterophasic polymer composition is any stereospecific catalyst for propylene polymerization which is capable of polymerizing and copolymerizing propylene and comonomers at a temperature of 40 to 110° C. and at a pressure from 10 to 100 bar. Ziegler-Natta as well as metallocene catalysts are suitable catalysts. One skilled in the art is aware of the various possibilities to produce such heterophasic polymers and will simply find out a suitable procedure to produce suitable heterophasic polymers which can be used in the present invention.

Especially preferred the heterophasic propylene copolymer (HECO) is the commercial product EF 015 AE of Borealis AG.

### Slip Agents

A slip agent according to this invention is an additive that gradually migrates to the surface and/or reduces the coefficient of friction of the surface of an article made from a composition containing said slip agent.

The finding of the present invention is that the composition of the automotive interior article comprises a slip agent which is a fatty acid amide derivative of formula (I) as follows:

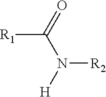

wherein R₁ is a C₅ to C₂₅ alkyl residue or C₅ to C₂₅ alkenyl residue
R₂ is a long-chain organic residue containing at least 6 carbon atoms.

Preferably the fatty acid amide derivative of formula (I) is the only slip agent in the composition, more preferably in the total automotive interior article.

Fatty acids, like fatty acid amides, are known to the skilled person. Typically a fatty acid and its derivatives contain an unbranched long chain aliphatic residue. Thus according to the present invention the residues of the slip agents are unbranched. More precisely the C₅ to C₂₅ alkyl residue or C₅ to C₂₅ alkenyl residue and the specific embodiments thereof are unbranched.

The term “long-chain organic residue” covers long chain aliphatic residues, like alkyl residues and alkenyl residues, as well as aliphatic residues comprising functional groups included in the chain, like —NH—CO—, —NH—, —CO—, or —O—.

The R₁ residue of the fatty acid amid derivative of formula (I) is preferably a C₁₀ to C₂₅ alkyl residue or C₁₀ to C₂₅ alkenyl residue.

The R₂ residue of the fatty acid amid derivative of formula (I) is preferably selected from the group consisting of an aliphatic amide derivative residue containing 6 to 30 carbon atoms, an aliphatic alkyl residue containing 5 to 30 carbon atoms, and an aliphatic alkeny residue containing 5 to 30 carbon atoms.

Thus in one specific embodiment the R₂ residue is a C₅ to C₂₅ alkyl residue or a C₅ to C₂₅ alkenyl residue.

In another specific embodiment the R₂ residue is R₄—NH—CO—R₅, with

R₄ being a covalent bond or a C₁ to C₆ alkyl residue, like —CH₂— or —CH₂—CH₂—, and
R₅ being a C₅ to C₂₅ alkyl residue or a C₅ to C₂₅ alkenyl residue, more preferably a C₅ to C₂₅ alkyl residue.

In one preferred embodiment the fatty acid amid derivative is of formula (Ia)

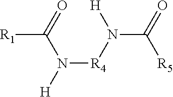

with
R₁ and R₅ being independently from each other a C₅ to C₂₅ alkyl residue, more preferably an unbranched C₅ to C₂₅ alkyl residue, still more preferably an unbranched C₁₀ to C₂₀ alkyl residue, like —(CH₂)ₙCH₃, with n being a positive integer between 12 to 18, like 16, and R₄ being a C₁ to C₆ alkyl residue, preferably an unbranched C₁ to C₆ alkyl residue, more preferably —CH₂— or —CH₂—CH₂—, still more preferably —CH₂—CH₂—.

It is especially preferred that R₁ and R₅ are identical and are —(CH₂)ₙCH₃, with n being a positive integer between 12 to 18, like 16. Accordingly in preferred embodiment the fatty acid amid derivative of formula (Ia) as stated in the previous paragraph is N,N′-bisstearoylethylenediamide (CH₃(CH₂)₁₆CONHCH₂CH₂NHCO(CH₂)₁₆CH₃).

In another preferred embodiment the fatty acid amid derivative is of formula (Ia)

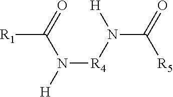

with
R₁ and R₅ being independently from each other a C₅ to C₂₅ alkenyl residue, more preferably an unbranched C₅ to C₂₅ alkenyl residue, still more preferably —(CH₂)ₓCH═CH(CH₂)_{y}CH₃, with x=4 to 15 and y=3 to 10, preferably with x being a positive integer between 7 to 15 and y being a positive integer between 4 to 9.
R₄ being a C₁ to C₆ alkyl residue, preferably an unbranched C₁ to C₆ alkyl residue, more preferably —CH₂— or —CH₂—CH₂—, still more preferably —CH₂—CH₂—.

It is especially preferred that R₁ and R₅ are identical and are —(CH₂)ₓCH═CH(CH₂)_{y}CH₃, with x being positive integers between 4 to 15 and y being positive integers between 3 to 10, preferably with x being a positive integer between 7 to 15 and y being a positive integer between 4 to 9. Accordingly in preferred embodiment the fatty acid amid derivative is of formula (Ib) is N,N′-ethylene-bis-oleamide.

In still another preferred embodiment the fatty acid amid derivative is of formula (Ib) with

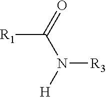

R₁ being a C₅ to C₂₅ alkyl residue, more preferably an unbranched C₅ to C₂₅ alkyl residue, still more preferably an unbranched C₁₀ to C₂₀ alkyl residue, like —(CH₂)ₙCH₃, with n being a positive integer between 12 to 18, like 14, and
R₃ being a C₅ to C₂₅ alkyl residue or C₅ to C₂₅ alkenyl residue, preferably a C₅ to C₂₅ alkenyl residue, more preferably a —(CH₂)ₓCH═CH(CH₂)_{y}CH₃, with x being a positive integer between 4 to 15 and y being a positive integer between 3 to 10, preferably with x being a positive integer between 7 to 15 and y being a positive integer between 4 to 9.

Thus it is especially preferred that

R₁ is —(CH₂)ₙCH₃, with n being a positive integer between 12 to 18, like 14, and
R₃ is —(CH₂)ₓCH═CH(CH₂)_{y}CH₃, with x being a positive integer between 4 to 15 and y being a positive integer between 3 to 10, preferably with x being a positive integer between 7 to 15 and y being a positive integer between 4 to 9.

Accordingly in preferred embodiment the fatty acid amid derivative of formula (Ib) is N-9-octadecenyl hexadecanamide.

In yet another preferred embodiment the fatty acid amid derivative is of formula (Ib) with

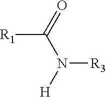

R₁ being a C₅ to C₂₅ alkenyl residue, preferably an unbranched C₅ to C₂₅ alkenyl residue, more preferably an unbranched C₁₀ to C₂₀ alkenyl residue, still more preferably—(CH₂)ₓCH═CH(CH₂)_{y}CH₃, with x a positive integer between 4 to 15 and y a positive integer between 3 to 10, preferably with x a positive integer between 7 to 15 and y a positive integer between 4 to 9,
R₃ being a C₅ to C₂₅ alkyl residue or C₅ to C₂₅ alkenyl residue, preferably a C₅ to C₂₅ alkyl residue, more preferably an unbranched C₅ to C₂₅ alkyl residue, still more preferably an unbranched C₁₀ to C₂₀ alkyl residue, like —(CH₂)ₙCH₃, with n a positive integer between 12 to 18, like 14.

Thus it is especially preferred that

R₁ is —(CH₂)ₓCH═CH(CH₂)_{y}CH₃, with x a positive integer between 4 to 15 and y a positive integer between 3 to 10, preferably with x a positive integer between 7 to 15 and y a positive integer between 4 to 9, and
R₃ is —(CH₂)ₙCH₃, with n a positive integer between 12 to 18, like 14.

Accordingly in preferred embodiment of the previous paragraph the fatty acid amid derivative of formula (Ib) is N-octadecyl-13-docosenamide

It is especially preferred that the fatty acid amid derivative of is of formula (Ia) and in particular is N,N′-bisstearoylethylenediamide

(CH₃(CH₂)₁₆CONHCH₂CH₂NHCO(CH₂)₁₆CH₃).

Preferably the fatty acid amide derivative is contained in a range of 2500 ppm to 18000 ppm, in particular preferred in a range of 4000 ppm to 8000 ppm.

### Additional Components

The composition of the automotive (interior) article may additionally contain

(d) inorganic filler
and/or
(e) polypropylene homopolymer
and/or
(f) high density polyethylene (HDPE).

Also further additives know by a person skilled in the art can be contained apart from those preferably disclaimed below. One typical example of such further additives are antioxidants.

Preferably the inorganic filler is a phyllosilicate, mica or wollastonite. Even more preferred the inorganic filler is selected from the group consisting of mica, wollastonite, kaolinite, smectite, montmorillonite and talc. The most preferred the inorganic filler is talc.

The mineral filler preferably has a cutoff particle size d95 [mass percent] of equal or below 20 μm, more preferably below 10.0 μm, like below 8.0 μm.

Typically the inorganic filler has a surface area measured according to the commonly known BET method with N₂ gas as analysis adsorptive of less than 22 m²/g, more preferably of less than 20 m²/g, yet more preferably of less than 18 m²/g. Inorganic fillers fulfilling these requirements are preferably anisotropic mineral fillers, like talc, mica and wollastonite.

To improve further the stiffness of the composition for instance a propylene homopolymer and/or a high density polyethylene can be added.

Preferably the propylene homopolymer has a melt flow rate MFR₂ (230° C.) of 10.0 to 50.0 g/10 min, more preferably from 15.0 to 40.0 g/10 min.

If present, the high density polyethylene (HDPE) has preferably a density measured according to ISO 1183 in the range of 0.954 to 0.966 g/cm³ and a melt flow rate (MFR₂ at 190° C.) of 1.0 to 50.0 g/10 min, more preferably from 5.0 to 40.0 g/10 min.

### Composition

As already mentioned above the composition being used for the automotive interior article must comprise:

(a) a heterophasic propylene copolymer (HECO)
and
(b) a fatty acid amide derivative of formula (I)

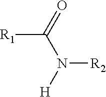

wherein R₁ is a C₅ to C₂₅ alkyl residue or C₅ to C₂₅ alkenyl residue
R₂ is a long-chain organic residue containing at least 6 carbon atoms.

Preferred embodiments of the heterophasic propylene copolymer (HECO) are described in the section “heterophasic propylene copolymer” whereas preferred fatty acid amide derivative are described in the section “slip agents”.

Optionally a propylene homopolymer and/or inorganic filler and/or a high density polymer (HDPE) can be present.

Thus the composition for the automotive interior article preferably comprises
(a) at least 40 wt.-%, more preferably 40 to 95 wt.-%, yet more preferably 45 to 60 wt-%, of the heterophasic propylene copolymer (HECO),
(b) at least 2500 ppm, preferably 2500 to 18000 ppm, yet more preferably 4000 to 8000 ppm, of a fatty acid amide derivative of formula (I)

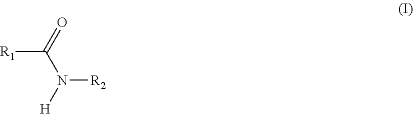

wherein
R₁ is a C₅ to C₂₅ alkyl residue or C₅ to C₂₅ alkenyl residue
R₂ is a long-chain organic residue containing at least 6 carbon atoms,
(c) optionally at least 5 wt.-%, more preferably 5 to 30 wt.-%, yet more preferably 7 to 25 wt.-%, of propylene homopolymer,
(d) optionally at least 5 wt.-%, more preferably 5 to 30 wt.-%, yet more preferably 10 to 20 wt.-%, of inorganic filler, and
(e) optionally at least 5 wt.-%, more preferably 5 to 30 wt.-%, yet more preferably 7 to 20 wt.-%, of high density polyethylene (HDPE).

The composition of the present invention can be prepared by any suitable method known in the art, such as by blending the heterophasic propylene copolymer (HECO), the fatty acid amide of formula (I) and the additional polymer components, if present, as well as any optional further additives listed above, either directly, e.g. in an extruder, such that the same extruder is used to make the finished product, or by melt pre-mixing in a separate mixer or extruder. For mixing, a conventional compounding or blending apparatus, e.g. a Banburry mixer, a 2-roll rubber mill, Buss-co-kneader or a twin screw extruder may be used.

Furthermore the use of a composition comprising

(a) a heterophasic propylene copolymer (HECO) and
(b) a fatty acid amide derivative of the formula (I)

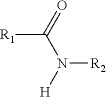

wherein R₁ is a C₅ to C₂₅ alkyl residue or C₅ to C₂₅ alkenyl residue and R₂ is a long-chain organic residue containing at least 6 carbon atoms
   for production of an automotive interior article as described before is inventive.

Additionally the invention encompasses the use of a composition comprising

(a) a heterophasic propylene copolymer (HECO)
(b) a fatty acid amide derivative of formula (I)

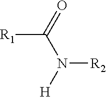

wherein
R₁ is a C₅ to C₂₅ alkyl residue or C₅ to C₂₅ alkenyl residue and
R₂ is a long-chain organic residue containing at least 6 carbon atoms,
   wherein the long term scratch resistance of an article, preferably of an automotive (interior) article, containing a fatty acid amide of formula (I) is improved and/or the surface tack is reduced in comparison with an article comprising the same composition without a slip agent.

Concerning the preferred embodiments of the heterophasic propylene copolymer (HECO) and the fatty acid amide derivative, respectively, reference is made to the information provided above.

The composition of the present invention is preferably used for the production of automotive articles, like molded automotive articles, preferably automotive injection molded articles. Even more preferred is the use of the inventive composition for the production of car interiors like body panels and the like.

According to a preferred embodiment of the present invention, the composition of the present invention is used for the production of automotive articles, preferably interior automotive articles, more preferably dash boards, instrument panels, door claddings, arm rests, gear sticks, shift lever knobs, mats, interior skins, trunk claddings, or interior trims.

Moreover the present invention is directed to the use of a slip agent being a fatty acid amide derivative of formula (I)

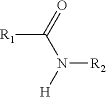

wherein
R₁ is a C₅ to C₂₅ alkyl residue or C₅ to C₂₅ alkenyl residue and
R₂ is a long-chain organic residue containing at least 6 carbon atoms in a polypropylene, preferably in a heterophasic propylene copolymer (HECO), for improving the long term scratch resistance and/or for reducing the surface tack of the polypropylene, preferably of the heterophasic propylene copolymer (HECO), and/or of an automotive (interior) article comprising the polypropylene, i.e. the heterophasic propylene copolymer (HECO).

The expression “polypropylene” as used throughout the instant invention covers any polypropylene, like a propylene homopolymer, a random propylene copolymer or a heterophasic propylene copolymer. Preferably the polypropylene is a heterophasic propylene copolymer (HECO) as defined herein. Thus, concerning the preferred embodiments of the heterophasic propylene copolymer (HECO) and the fatty acid amide derivative, respectively, reference is made to the information provided above. Accordingly, particular preferred is the use of fatty acid amide derivatives according to formulas (Ia) and (Ib).

Preferably the improvement of scratch resistance is determined as the long term scratch resistance (two weeks after molding and at 95° C.) [oven ageing], wherein the long term scratch resistance (two weeks after molding and at 95° C.) [oven ageing] of the propylene, preferably of the heterophasic propylene copolymer (HECO), is at least factor 4.0 lower, preferably at least a factor 5.0 lower, more preferably a factor 6.0 lower, like a factor 6.0 to 8.0 lower, than the long term scratch resistance (two weeks after molding and at 95° C.) of the same polypropylene, preferably the same heterophasic propylene copolymer (HECO), but without a slip agent. The measuring method for the scratch resistance is described in the example section.

Preferably the reduced surface tack is measured as the surface tack factor (especially after two weeks at 95° C.), wherein the surface tack factor (especially after two weeks at 95° C.) [oven ageing] of the polypropylene, preferably the heterophasic propylene copolymer (HECO), is at least a factor 1.8 lower, more preferably at least a factor 2.5 lower, like a factor 2.2 to 3.0 lower, than the surface tack factor (especially after two weeks at 95° C.) [oven ageing] of the same polypropylene, preferably of the same heterophasic propylene copolymer (HECO), but without a slip agent. The measuring method for the surface tack factor is described in the example section.

By using the described compositions respectively slip agents for the production of automotive interior articles there can be obtained an improved long term scratch and reduced surface tack of these articles. Accordingly the values provided with regard to the long term scratch resistance (especially after two weeks at 95° C.) [oven ageing] and the surface tack factor (especially after two weeks at 95° C.) [oven ageing] for the polypropylene as such are equally applicable for automotive (interior) articles comprising the instant composition and/or slip agent as defined above

It was found surprisingly that the article according to the invention shows much better properties regarding the scratch resistance as well as the surface tack by higher temperatures and after longer times, e.g. two weeks.

Especially at temperatures of 80° C. or higher temperatures (i.e. 90° C.) the inventive automotive interior article shows much better properties regarding especially scratch resistance and surface tack as articles made of state of the art compositions.

This property is necessary e.g. for automotive interior articles, which have to stay unscratched for many years although they are exposed to quite different influences.

The present invention will now be described in further detail by the examples provided below.

### EXAMPLE

### 1 Measuring Methods

The following definitions of terms and determination methods apply for the above general description of the invention as well as to the below examples unless otherwise defined.

The Density was measured according to ISO 1183-1—method A (2004). Sample preparation is done by compression moulding in accordance with ISO 1872-2:2007.

The ethylene content was measured with Fourier transform infrared spectroscopy (FTIR) calibrated with ¹³C-NMR. When measuring the ethylene content in propylene, a thin film of the sample (thickness about 250 μm) was prepared by hot-pressing. The area of absorption peaks 720 and 733 cm⁻¹ was measured with Perkin Elmer FTIR 1600 spectrometer. The method was calibrated by ethylene content data measured by ¹³C-NMR.

### Molecular Weights, Molecular Weight Distribution (Mn, Mw, MWD)

Mw/Mn/MWD were measured by Gel Permeation Chromatography (GPC) according to the following method:

The weight average molecular weight Mw and the molecular weight distribution (MWD=Mw/Mn wherein Mn is the number average molecular weight and Mw is the weight average molecular weight) is measured by a method based on ISO 16014-1:2003 and ISO 16014-4:2003. A Waters Alliance GPCV 2000 instrument, equipped with refractive index detector and online viscosimeter was used with 3×TSK-gel columns (GMHXL-HT) from TosoHaas and 1,2,4-trichlorobenzene (TCB, stabilized with 200 mg/L 2,6-Di tert butyl-4-methyl-phenol) as solvent at 145° C. and at a constant flow rate of 1 mL/min. 216.5 μL of sample solution were injected per analysis. The column set was calibrated using relative calibration with 19 narrow MWD polystyrene (PS) standards in the range of 0.5 kg/mol to 11 500 kg/mol and a set of well characterised broad polypropylene standards. All samples were prepared by dissolving 5-10 mg of polymer in 10 mL (at 160° C.) of stabilized TCB (same as mobile phase) and keeping for 3 hours with continuous shaking prior sampling in into the GPC instrument.

The MFR₂ (230° C.) was measured according to ISO 1133 (230° C., 2.16 kg load).

The MFR₂ (190° C.) was measured according to ISO 1133 (190° C., 2.16 kg load).

The gloss was measured on injection moulded grained specimen according to DIN 67530 at an angle of 60°. The grain for gloss measurements was identical to the grain used in evaluation of scratch visibility.

The content of xylene cold solubles (XCS, wt.-%) was determined at 25° C. according ISO 16152; first edition; 2005-07-01.

Particle size is measured according to ISO 13320-1:1999

The intrinsic viscosity was measured according to DIN ISO 1628/1, October 1999 (in decalin at 135° C.).

The tensile modulus was measured according to ISO 527-2 (cross head speed=1 mm/min; 23° C.) using injection moulded specimens as described in EN ISO 1873-2 (dog bone shape, 4 mm thickness).

### Scratch Visibility

To determine the scratch visibility a Cross Hatch Cutter Model 420P, manufactured by Erichsen, was used. For the tests, plaques of 70×70×4 mm size were cut from a moulded grained (grain parameters: average grain size=1 mm, grain depth=0.12 mm, conicity=6°) plaque of size 140×200×4 mm. The minimum period between injection moulding of specimens and scratch-testing was 7 days.

For testing the specimens must be clamped in a suitable apparatus as described above. Scratches were applied at a force of 10 N or 15 N using a cylindrical metal pen with a ball shaped end (radius=0.5 mm±0.01). A cutting speed of 1000 mm/min was used.

A minimum of 20 scratches parallel to each other were brought up at a load of 10 N with a distance of 2 mm. The application of the scratches was repeated perpendicular to each other, so that the result was a scratching screen. The scratching direction should be unidirectional. The scratch visibility is reported as the difference of the luminance ΔL of the unscratched from the scratched areas. ΔL values were measured using a spectrophotometer that fulfils the requirements to DIN 5033. Light source for quantification of ΔL D65/10°. Measured ΔL values must be below a maximum of 1.5.

A detailed test description of the test method (Erichsen cross hatch cutter method) can be found in the article “Evaluation of scratch resistance in multiphase PP blends” by Thomas Koch and Doris Machl, published in POLYMER TESTING 26 (2007), p. 927-936.

### Surface Tack

The surface tack measurement was performed on injection moulded multigrain plaques with a film gate using the grain K29. The K29 surface is defined as a grain with a grain depth of 0.01 mm, and a minimum draft angle of 1° for ejection from the injection moulding tool. The section with this grain was cut out from the plaque with a bench shear.

To perform the experiments an Instron tensile testing machine was used (ElectroPuls E3000, Instron Deutschland GmbH, Germany) with an elastomer die tip having a diameter of 25 mm and a thickness of 5 mm. The compressive force F was −50 N, the holding time t_{H} was 91 s, and the haul-off speed ν was 55 mm/s. The tests were performed at standard laboratory climate conditions (23° C. and 50% relative humidity). Each single surface tack measurement was performed with this setup in the following way: After the elastomer (NR/SBR) tip had been cleaned and attached to the die by means of a double-side adhesive tape, the tackiness force F_{T} of both the aluminium reference and the specimen (sample) were measured. The surface tack is reported as tack quotient QT, which was calculated by the following Equation:

$${Q}_{T} = \frac{{F}_{T , sample}}{{F}_{T , reference}}$$

and averaged over a minimum of three successive measurements.

A detailed description of the test method for quantifying surface tack can also be found in the paper “A novel test method for quantifying surface tack of polypropylene compound surfaces” by [symbol] akmak et al., which will be published in eXPRESS Polymer Letters in 2011.

### UV-Aging

For weathering, the specimens were faced around a light source in an environmental chamber (WeatherOmeterCi4000, Atlas Material Testing Technology GmbH; Linsengericht, Germany) and artificially weathered using the Kalahari weathering condition. The weathering conditions of the chamber were:
Light source: Xenon arc light
Filter: Pyrex S
Black standard temperature: 90° C.
Chamber temperature in the dry phase: 50° C.
Relative humidity: 20%
Intensity of irradiation (300-400 nm): 75 W/m².

After the UV exposure the specimens were conditioned for approximately 1 h at 23° C. and 50% relative humidity before testing surface tack.

5 plaques of each material were put into the UV chamber (PV3929 dry and hot—Kalahari test). After 24, 48, 96, 192 and 384 h one plaque per material was taken out of the chamber. For each of these samples Surface tack and scratch resistance were determined

### Oven Ageing of Samples

For thermal ageing, the specimens were put into a fan oven at 80° C. and 95° C. In the current investigation the specimens were aged for 7 and 14 days. After the temperature exposure the specimens were conditioned for approximately 1 h at 23° C. and 50% relative humidity before testing surface tack.

### 2 Examples

One polymer composition according to the present invention (IE: inventive example) and six comparative compositions (CE: comparative examples) were prepared. The components of the compositions are listed on table 1.

The polymer compositions were prepared by melt blending the components on a corotating twin screw extruder type Coperion ZSK 40 (screw diameter 40 mm. L7/D ratio 38) at temperatures in the range of 170-190° C., using a high intensity mixing screw configuration with two sets of kneading blocks.

TABLE 1
Compositions

| | Unit | C1 | C2 | C3 | C4 | C5 | IE |
|---|---|---|---|---|---|---|---|
| H-PP | [wt.-%] | 58.5 | 58.3 | 58.4 | 57.9 | 56.5 | 57.9 |
| PP | [wt.-%] | 12.0 | 12.0 | 12.0 | 12.0 | 12.0 | 12.0 |
| HDPE | [wt.-%] | 11.0 | 11.0 | 11.0 | 11.0 | 11.0 | 11.0 |
| IF | [wt.-%] | 17.0 | 17.0 | 17.0 | 17.0 | 17.0 | 17.0 |
| ESA | [wt.-%] | | 0.2 | | | | |
| ÖSA | [wt.-%] | | | 0.15 | | | |
| SR | [wt.-%] | | | | 0.6 | | |
| EBS | [wt.-%] | | | | | | 0.6 |
| Tego | [wt.-%] | | | | | 2.0 | |

*the remaining part to 100 wt.-% are additives and colorants
H-PP is the commercial heterophasic propylene copolymer “EF015AE” of Borealis AG having a melt flow rate MFR₂ (230° C.) of 18 g/10 min, a XCS of 29 wt.-%, and an ethylene content (C2) of 20 wt.-%
PP is the commercial propylene homopolymer “HF955MO” of Borealis AG having a melt flow rate MFR₂ (230° C.) of 20 g/10 min
HDPE is the commercial high density polyethylene “MG9641B” of Borealis AG having a melt flow rate MFR₂ (190° C.) of 8 g/10 min and a density of 964 kg/m³
IF is the commercial product “Steamic T1 CA” of Luzenac having a median particle size d50 of 2.1 μm
ESA is the commercial erucamide “Finawax E” of Fine organics
ÖSA is the commercial 9-octadecenamide “Chrodamide OR” of Croda Chemical
SR is the commercial stearamide “Crodamide SR” of Croda Chemical
EBS is the commercial NN′-bisstearoylethylenediamide “Licolub FA6” of Clariant
Tego is the commercial product “Tegomer AS100” of Evonik

TABLE 2
Properties in unstored state

| | Unit | C1 | C2 | C3 | C4 | C5 | IE |
|---|---|---|---|---|---|---|---|
| MFR 230° C./ | g/10 min | 14.4 | 15.0 | 15.4 | 16.6 | 16.0 | 16.0 |
| 2.16 kg | | | | | | | |
| Delta 1 w | None | 4.69 | 1.16 | 0.91 | 2.23 | 1.05 | 4.62 |
| Gloss 60° on K09 | [%] | 3.3 | 3.0 | 3.3 | 3.3 | 3.5 | 3.4 |
| Tack quotient Q_{T} | none | 0.67 | 0.60 | 0.88 | 0.68 | 0.74 | 0.78 |

Delta 1 w delta one week after moulding

TABLE 3
Surface properties after artificial wheatering at various times

| | | | | | | | |
|---|---|---|---|---|---|---|---|
| Delta L 24 h | None | 4.69 | 1.16 | 0.91 | 2.23 | 1.05 | 4.62 |
| Delta L 48 h | None | 2.48 | 1.51 | 3.31 | 1.93 | 0.92 | 2.65 |
| Delta L 96 h | None | 3.53 | 1.44 | 3.69 | 1.80 | 0.92 | 1.55 |
| Delta L 192 h | None | 3.53 | 1.54 | 3.56 | 2.24 | 0.91 | 1.09 |
| Delta L 384 h | None | 3.14 | 2.03 | 3.12 | 2.31 | 0.52 | 1.38 |
| Tack quotient Q_{T} 24 h | None | 0.57 | 0.62 | 0.56 | 0.71 | 0.67 | 0.51 |
| Tack quotient Q_{T} 48 h | None | 0.85 | 0.68 | 0.97 | 0.83 | 0.63 | 0.58 |
| Tack quotient Q_{T} 96 h | None | 0.75 | 0.66 | 0.66 | 0.88 | 0.66 | 0.33 |
| Tack quotient Q_{T} | None | 0.61 | 0.58 | 0.79 | 0.73 | 0.46 | 0.51 |
| 192 h | | | | | | | |
| Tack quotient Q_{T} | None | 0.75 | 0.45 | 0.64 | 0.70 | 0.49 | 0.31 |
| 384 h | | | | | | | |

TABLE 4
Surface properties after 14 days oven-ageing at different temperatures

| | Unit | C1 | C2 | C3 | C4 | C5 | IE |
|---|---|---|---|---|---|---|---|
| Delta L 65° C. | None | 3.70 | 1.64 | 2.47 | 0.16 | 1.65 | 3.20 |
| Delta L 80° C. | None | 3.37 | 1.20 | 1.82 | 1.86 | 1.04 | 0.29 |
| Delta L 95° C. | None | 3.38 | 1.76 | 3.20 | 2.14 | 1.52 | 0.40 |
| Tack quotient Q_{T} | None | 0.94 | 0.83 | 0.91 | 0.58 | 0.73 | 0.65 |
| 65° C. | | | | | | | |
| Tack quotient Q_{T} | None | 0.82 | 0.69 | 0.81 | 0.63 | 0.74 | 0.31 |
| 80° C. | | | | | | | |
| Tack quotient Q_{T} | None | 0.99 | 0.90 | 0.59 | 0.80 | 0.80 | 0.32 |
| 95° C. | | | | | | | |

1. Automotive interior article comprising a composition comprising:
(a) a heterophasic propylene copolymer (HECO), and
(b) a fatty acid amide derivative of formula (I): 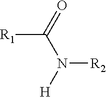
wherein
R₁ is a C₅ to C₂₅ alkyl residue or C₅ to C₂₅ alkenyl residue,
R₂ is a long-chain organic residue containing at least 6 carbon atoms.

2. Automotive interior article according to claim 1, wherein the fatty acid amide derivative is of formula (Ia): 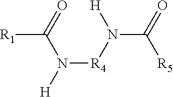
wherein,
R₁ and R₅ being independently from each other a C₅ to C₂₅ alkyl residue,
R₄ being a C₁ to C₆ alkyl residue.

3. Automotive interior article according to claim 1, wherein the fatty acid amide derivative of formula (Ia) is N,N′-bisstearoylethylenediamide.

4. Automotive interior article according to claim 1, the composition comprises additionally;
(c) an inorganic filler
and/or
(d) a polypropylene homopolymer
and/or
(e) a high density polyethylene (HDPE).

5. Automotive interior article according to claim 1, wherein a saturated fatty acid amide derivative of formula (I) is the only slip agent being contained in the composition and/or in the automotive interior article.

6. Automotive interior article according to claim 1, wherein the composition comprises:
(a) 40 to 95 wt. %, of the heterophasic propylene copolymer (HECO),
(b) 2500 to 18000 ppm of the fatty acid amide derivative,
(c) optionally 5 to 30 wt. % of a propylene homopolymer,
(d) optionally 5 to 30 wt. % of a inorganic filler, and
(e) optionally 5 to 30 wt. % of a high density polyethylene (HDPE).

7. (canceled)

8. The automotive interior article of claim 1, wherein the long term scratch resistance of the article is improved and/or the surface tack is reduced in comparison with the same article but without a slip agent.

9. A heterophasic propylene copolymer (HECO) comprising a slip agent, the slip agent being a fatty acid amide derivative of formula (I): 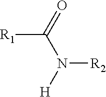
wherein,
R₁ is a C₅ to C₂₅ alkyl residue or C₅ to C₂₅ alkenyl residue,
R₂ is a long-chain organic residue containing at least 6 carbon atoms,
the slip agent improving the long term scratch resistance in comparison with the same heterophasic propylene copolymer (HECO), but without a slip agent.

10. The HECO of claim 9, wherein the slip agent reduces surface tack of the, in comparison with the same HECO, but without a slip agent.

11. A heterophasic propylene copolymer (HECO) comprising a slip agent, the slip agent being a fatty acid amide derivative of formula (I): 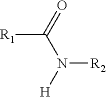
wherein,
R₁ is a C₅ to C₂₅ alkyl residue or C₅ to C₂₅ alkenyl residue,
R₂ is a long-chain organic residue containing at least 6 carbon atoms,
the slip agent reducing surface tack in comparison with the same HECO, but without a slip agent.

12. The HECO of claim 11, wherein the slip agent improves the long term scratch resistance of the heterophasic propylene copolymer (HECO), in comparison with the same HECO, but without a slip agent.

13. The automotive interior article of claim 8, wherein the long term scratch resistance of the HECO, is at least factor 4.0 lower than the long term scratch resistance of the same HECO, without a slip agent.

14. The automotive article of claim 8,
wherein the surface tack is determined by the surface tack factor, the surface tack factor of the HECO, is at least a factor 1.8 lower than the surface tack factor of the same HECO, without a slip agent.

15. The HECO of claim 9, wherein the long term scratch resistance of the HECO, is at least factor 4.0 lower than the long term scratch resistance of the same HECO, without a slip agent.

16. The HECO of claim 12, wherein the long term scratch resistance of the HECO, is at least factor 4.0 lower than the long term scratch resistance of the same HECO, without a slip agent.

17. The HECO of claim 10, wherein the surface tack is determined by the surface tack factor, the surface tack factor of the HECO, is at least a factor 1.8 lower than the surface tack factor of the same HECO, without a slip agent.

18. The HECO of claim 11, wherein the surface tack is determined by the surface tack factor, the surface tack factor of the HECO, is at least a factor 1.8 lower than the surface tack factor of the same HECO, without a slip agent.
